(19) United States
(12) Patent Application Publication
(10) Pub. No.: US 2026/0279962 A1
(43) Pub. Date: Sep. 17, 2026

(54) BATTERY PACK AND BATTERY CLUSTER

(71) Applicant: EVE ENERGY STORAGE CO., LTD, Wuhan (CN)

(72) Inventors: Zhonghui YU, Wuhan (CN); Weikang XIE, Wuhan (CN); Shilin FAN, Wuhan (CN); Chaojun FENG, Wuhan (CN); Muhong GONG, Wuhan (CN); Yuan ZHU, Wuhan (CN)

(73) Assignee: EVE ENERGY STORAGE CO., LTD, Wuhan (CN)

(21) Appl. No.: 19/676,984

(22) Filed: May 14, 2026

Related U.S. Application Data
(63) Continuation of application No. PCT/CN2024/139280, filed on Dec. 13, 2024.

(30) Foreign Application Priority Data
Oct. 25, 2024 (CN) 202411501107.4
Oct. 25, 2024 (CN) 202422603043.0

(51) Int. Cl. H01M 10/6563; H01M 10/613; H01M 10/651; H01M 10/6551; H01M 10/6567; H01M 10/6569; H01M 50/204; H01M 50/271

(52) U.S. Cl. CPC H01M 10/6563; H01M 10/613; H01M 10/651; H01M 10/6551; H01M 10/6567; H01M 10/6569; H01M 50/271; H01M 50/204

(57) ABSTRACT

A battery pack and a battery cluster are provided. The battery pack includes a case having an accommodating cavity, a plurality of cells spaced in the accommodating cavity, a plurality of vapor chambers, and an air-exhausting member. Each cell includes a main side and a main top, main sides of adjacent cells are opposite to each other, and the main top is a face through which poles of the cell extend. Each of the vapor chambers is attached to an end of the main side close to the main top, and the vapor chamber has at least a protruded part relative to the main top. A heat-dissipating member is connected to the protruded part of the vapor chamber. The air-exhausting member is provided in the accommodating cavity toward the heat-dissipating member.

### CROSS-REFERENCE TO RELATED APPLICATIONS

This application is a U.S. bypass continuation of International Application No. PCT/CN2024/139280, filed on Dec. 13, 2024, which claims priority to Chinese Application No. 202411501107.4, and Chinese Application No. 202422603043.0, both filed on Oct. 25, 2024. The entire contents of each of the above-referenced applications are expressly incorporated herein by reference.

### TECHNICAL FIELD

The present disclosure generally relates to energy storage, and more particularly, to a battery pack and a battery cluster.

### BACKGROUND

For high-power battery clusters, both in fields of energy storage batteries and in fields of power batteries, temperature uniformity and heat dissipation are always challenges for the industry. Conventional heat dissipation methods for batteries include immersive liquid-cooling systems, and double-sided liquid-cooling techniques.

Immersive liquid-cooling systems have compatibility issues and are costly. In double-sided liquid-cooling techniques, liquid cooling at the top has limited heat dissipation effect and may have condensation due to a fact that a heat-dissipating member can only contact an aluminum bar.

### SUMMARY

Some embodiments of the present disclosure provide a main side and a main top, main sides of adjacent cells of the plurality of cells are opposite to each other, and the main top is a face through which poles of the cell extend. Each of the plurality of vapor chambers is attached to an end of the main side close to the main top, and the vapor chamber has at least a protruded part relative to the main top. A heat-dissipating member is connected to the protruded part of the vapor chamber. The air-exhausting member is provided in the accommodating cavity, and an air-exhausting opening of the air-exhausting member is provided toward the heat-dissipating member.

The present disclosure also provides a battery cluster including the battery pack as described above.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the disclosure.

FIG. 1 is a schematic structural diagram of an exemplary battery cluster according to an embodiment of the present disclosure.

FIG. 2 is a schematic cross-sectional view in a first direction of an exemplary battery pack from according to an embodiment of the present disclosure.

FIG. 3 is a schematic cross-sectional view in a second direction of an exemplary battery pack according to an embodiment of the present disclosure.

FIG. 4 is a schematic structural diagram showing an exemplary assembly of two cells, two vapor chambers, a first elastic member, and a second elastic member according to an embodiment of the present disclosure.

FIG. 5 is an exemplary schematic cross-sectional view along IV-IV direction in FIG. 4 according to an embodiment of the present disclosure.

FIG. 6 is a schematic structural diagram of an exemplary vapor chamber according to an embodiment of the present disclosure.

FIG. 7 is a schematic partially enlarged view of an exemplary region A in FIG. 5 according to an embodiment of the present disclosure.

### REFERENCE NUMERALS

battery pack 100, case 10, accommodating cavity 101, cover 12, bottom 14, and air-cooling chamber 102; liquid-cooling chamber 103, cell 20, main side 21, main top 23, vapor chamber 30; main body 31, extending portion 32, bending portion 33, heat-dissipating member 40, base 41, fin 42, and air duct 43; air-exhausting member 50, first elastic member 60, and second elastic member 70.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented.

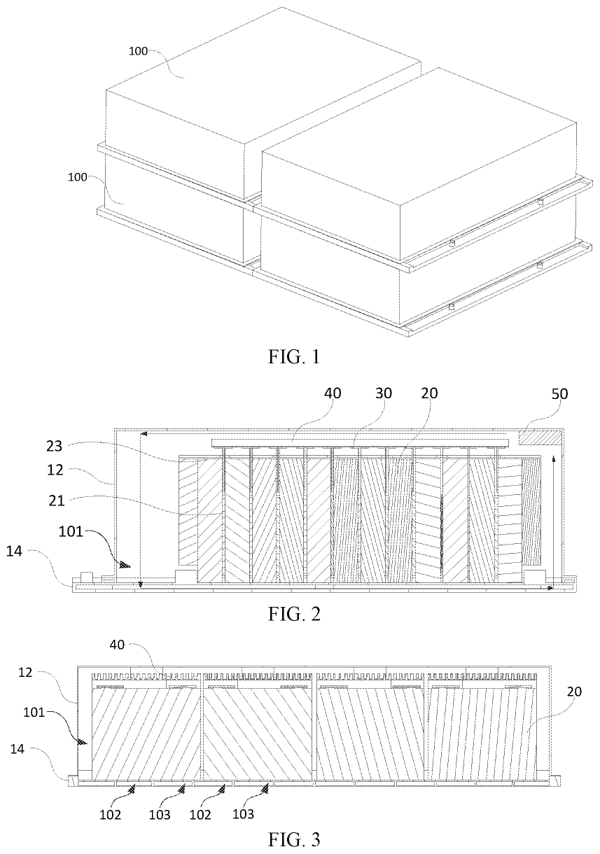

Reference is made to FIG. 1 which is a schematic structural diagram of an exemplary battery cluster according to an embodiment of the present disclosure.

A battery cluster includes a battery pack 100, and a control unit electrically connected to the battery pack 100. The control unit is configured to control a temperature of the battery pack 100 and an electrical operating condition. A plurality of the battery packs 100 may be provided, and the plurality of the battery packs 100 may be stacked together. The plurality of the battery packs 100 may be stacked together in a thickness direction thereof, or may be arranged together in the thickness direction, a length direction, and a width direction thereof at a same time.

Referring to FIG. 1 to FIG. 3, FIG. 2 is a schematic cross-sectional view in a first direction of an exemplary battery pack according to an embodiment of the present disclosure, and FIG. 3 is a schematic cross-sectional view in a second direction of an exemplary battery pack according to an embodiment of the present disclosure. The first direction and the second direction are perpendicular to each other.

The battery pack 100 includes a case 10, a plurality of cells 20, a plurality of vapor chambers 30, a heat-dissipating member 40, and an air-exhausting member 50.

The plurality of cells 20 are provided in an accommodating cavity 101 at intervals, adjacent cells 20 are spaced at a distance, and each of the plurality of cells 20 includes a main side 21 and a main top 23. The main top 23 is a face through which poles of the cell 20 extend, the main side 21 is adjacent to the main top 23, and the main side 21 may have a largest area among peripheral sides of the cell 20. The main sides 21 of the adjacent cells 20 are opposed to each other and are spaced apart from each other.

The vapor chamber 30 is a vacuum cavity having microstructures on inner walls, and is generally made of copper. When heat is conducted from a heat source to an evaporation zone, a cooling medium in the cavity begins to gasify after being heated in an environment of low vacuum degree. At this time, heat energy is absorbed and volume is rapidly expanded, and the cooling medium in a gas phase rapidly fills the entire cavity. Condensation occurs when the cooling medium in the gas phase contacts a relatively cold area. The heat accumulated at a time of evaporation is released by an occurrence of condensation, and the condensed cooling medium is returned to the heat source by means of capillary pipes of the microstructures. This operation is circulated in the cavity.

The vapor chamber 30 is attached to an end of the main side 21 close to the main top 23. At least a part of the vapor chamber 30 protrudes relative to the main top 23, which means a part of the vapor chamber 30 being higher than the main top 23 and not in contact with the cell 20. The heat-dissipating member 40 is connected to the protruded part of the vapor chamber 30. The vapor chamber 30 is disposed between the adjacent cells 20. The vapor chambers 30 disposed between the adjacent cells 20 may be in contact with each other, or may be spaced apart from each other. The vapor chamber 30 abuts against the main side 21 of the cell 20, and the heat generated by the cell 20 during operation can be transferred to the vapor chamber 30 and dissipated to the heat-dissipating member 40 through the protruded part of the vapor chamber 30, thereby achieving an effective heat dissipation for the cell 20. An end of the vapor chamber 30 close to the heat-dissipating member 40 is referred to as a cold end, and an end of the vapor chamber 30 close to the battery is referred to as a hot end. A direction from the cold end to the hot end is from top to bottom, as such, the liquid in the vapor chamber 30 flows by gravity, thereby facilitating the vapor chamber 30 to achieve higher thermal conductivity.

In some embodiments, since more heat are concentrated around the poles of the cell 20, a high-temperature region of the cell 20 is mainly close to the poles. Therefore, the vapor chamber 30 is attached to an end of the main side 21 close to the main top 23, the heat generated around the poles of the cell 20 can be better conducted out by the vapor chamber 30, thereby reducing the temperature around the poles of the cell 20. Therefore, effective cooling of the high-temperature region of the cell 20 can be achieved, and an effective temperature-uniform state of the cell 20 can be maintained.

An air-exhausting member 50 is provided in the accommodating cavity 101. The air-exhausting member 50 may be a fan or a blower. An air-exhausting opening of the air-exhausting member 50 is provided toward the heat-dissipating member 40. The air-exhausting member 50 is configured to cause air in the accommodating cavity 101 to move in a directional manner to remove the heat from the heat-dissipating member 40. The air-exhausting member 50 may blow air toward the heat-dissipating member 40 to directly take away the heat. The air-exhausting member 50 may also blow air away from the heat-dissipating member 40, so that the air surrounding the heat-dissipating member 40 may move in a directional manner to take away the heat from the heat-dissipating member 40.

In the present disclosure, each cell 20 includes a main side 21 and a main top 23, the main sides 21 of adjacent cells 20 are opposite to each other, and the main top 23 is a face through which the poles of the cell 20 extend. A part of the vapor chamber 30 is in direct contact with an end of the main side 21 close to the main top 23, and the other part of the vapor chamber 30 is in contact with the heat-dissipating member 40. Heat from the end of the cell 20 close to the poles is smoothly transferred to the heat-dissipating member 40 through the vapor chamber 30. Under the action of the air-exhausting member 50, air around the heat-dissipating member 40 moves in a directional manner to carry away the heat. Such a cyclic operation effectively dissipates heat from the pole end of the cell 20 and prevent an overall temperature difference of the cell 20 from being too large. In addition, in the disclosed way the air-exhausting member 50 dissipates the heat, an occurrence of a short-circuit caused by condensation at the end of the cell 20 provided with the poles can be effectively prevented in comparison with a liquid-cooling manner.

The case 10 includes a cover 12 and a bottom 14, and the cover 12 and the bottom 14 are connected to form the accommodating cavity 101. The plurality of cells 20 are disposed on the bottom 14, and the cover 12 covers the plurality of cells 20. An air-cooling chamber 102 and a liquid-cooling chamber 103 are provided on the bottom 14 and are arranged alternatively, and the air-cooling chamber 102 and the liquid-cooling chamber 103 each extends in a direction perpendicular to the main side 21. The air-cooling chamber 102 and the liquid-cooling chamber 103 may be disposed on different layers or may be disposed on a same layer, the air-cooling chamber 102 is in communication with the accommodating cavity 101, and the air-cooling chamber 102 is a part of an air circulation flow passage. The air in the accommodating cavity 101 and the air in the air-cooling chamber 102 may be in communication, and the liquid-cooling chamber 103 is configured for receiving a coolant. When hot air flows through the air-cooling chamber 102, the coolant in the liquid-cooling chamber 103 may absorb a part of the heat, thereby reducing the temperature of the air in the air-cooling chamber 102. The coolant is in communication with an external circulating machine, and the coolant is continuously input and output, thereby reducing the temperature of the coolant in the liquid-cooling chamber 103.

The plurality of battery packs 100 are stacked together, and the cover 12 of the battery pack 100 is connected to the bottom 14 of an adjacent battery pack 100. The liquid-cooling chamber 103 on the battery pack 100 not only cools the air-cooling chamber 102 on itself, but also directly absorbs the heat and cooling the air in the adjacent accommodating cavity 101 because it contacts the cover 12 of the adjacent battery pack 100.

In the embodiment, the plurality of battery packs 100 are stacked together in a thickness direction thereof, and each battery pack 100 includes an air-cooling for heat dissipation at the top of the cell 20 and a liquid-cooling for heat dissipation at the bottom of the cell 20. The air-cooling for heat dissipation and the liquid-cooling for heat dissipation cooperate with each other, so that the temperature of the cell 20 is controlled without condensation at the top of the cell 20. In addition, the liquid-cooling chamber 103 in each battery pack 100 is located on the bottom 14. As such, upon the bottom 14 being contacted with the cover 12, the bottom 14 exchanges heat with the cover 12 to realize a heat exchange of the air in the accommodating cavity 101 and the liquid-cooling chamber 103. The liquid-cooling chamber 103 in the adjacent battery pack 100 is thus reused for heat dissipation and cooling.

In an embodiment, the air-cooling chamber 102 and the liquid-cooling chamber 103 are arranged along a thickness direction of the bottom 14, and the air-cooling chamber 102 is interposed between the cell 20 and the liquid-cooling chamber 103. In the present embodiment, the air-cooling chamber 102 and the liquid-cooling chamber 103 are located in different layers, the air-cooling chamber 102 is located in an upper layer, and the liquid-cooling chamber 103 is located in a lower layer. The air-cooling chamber 102 is closer to the cell 20, and the liquid-cooling chamber 103 is closer to the cover 12 of the adjacent battery pack 100. This has the advantage that the upper and lower layers of the bottom 14 are respectively in a temperature-uniform state to prevent the cell 20 from having an uneven temperature, and areas of the liquid-cooling chamber 103 can be increased to improve the cooling effect of the air-cooling chamber 102.

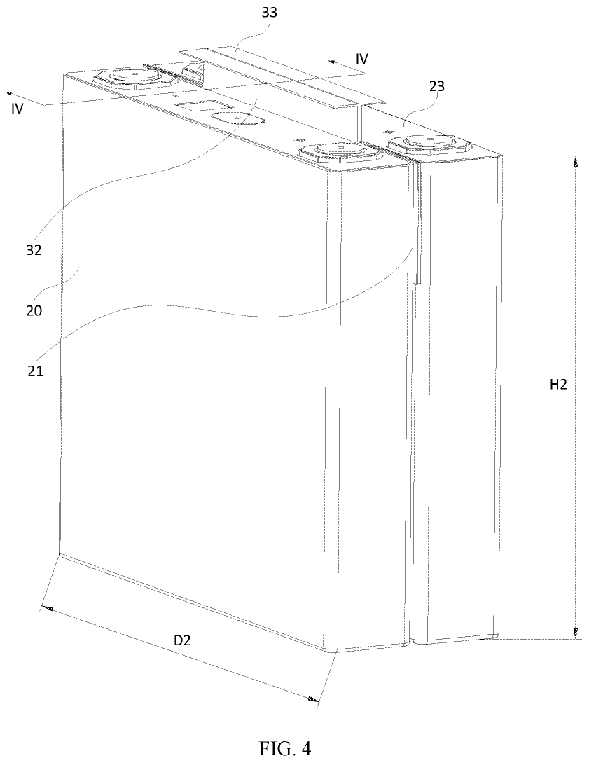

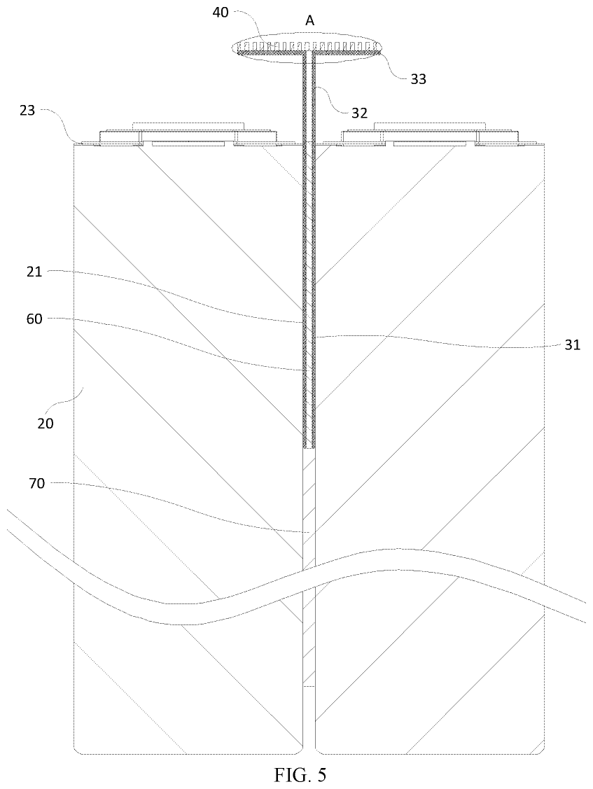

Referring to FIG. 4 and FIG. 5, FIG. 4 is a schematic structural diagram showing an assembly of two cells 20, two vapor chambers 30, a first elastic member 60, and a second elastic member 70 according to an embodiment of the present disclosure, and FIG. 5 is an exemplary schematic cross-sectional view along IV-IV direction in FIG. 4 according to an embodiment of the present disclosure.

The battery pack 100 further includes a first elastic member 60 disposed between adjacent vapor chambers 30. The first elastic member 60 has good elasticity and can be deformed during application. In some embodiments, the first elastic member 60 may be made of a material such as foam, rubber, or the like.

In some embodiments, there are tolerances in thickness of different cells 20 during production of the cells 20. Therefore, by providing the first elastic member 60 between the adjacent vapor chambers 30, the first elastic member 60 can eliminate the tolerances between the adjacent cells 20 during the assembly of the battery pack 100, so that initial mechanical state of each cell 20 is maintained. If thermal runaway causes expansion of the cell 20 during use, an expansion space may be created for the cell 20 by the first elastic member 60, thereby avoiding ignition of the cell 20. Therefore, the battery pack 100 according to the embodiment of the present disclosure can improve the stability and reliability of the battery pack 100 by using the first elastic member 60 to eliminate the tolerances between the adjacent cells 20, and to create an expansion space for the cell 20 and thermal exit of the cell 20. In addition, the first elastic member 60 also has a heat-insulating effect, and the heat on the adjacent vapor chambers 30 can be blocked from interference with each other.

The battery pack 100 also includes a second elastic member 70. The second elastic member 70 is disposed between the adjacent cells 20. The second elastic member 70 is attached to the main side 21. The second elastic member 70 may be attached to all regions of the main side 21 without the vapor chamber 30, or the second elastic member 70 may be just attached to a part region of the main side 21 without the vapor chamber 30. The second elastic member 70 has good elasticity and can be deformed during application. In practical applications, the second elastic member 70 may also be made of a material such as foam, rubber, or the like. The second elastic member 70 also has a heat-insulating effect, and can block the heat on the adjacent cells 20 from interference with each other.

In some embodiments, providing the battery pack 100 with the second elastic member 70 and disposing the second elastic member 70 between adjacent cells 20, a space for receiving the vapor chambers 30 between the adjacent cells is filled, making the overall structure of the battery pack 100 more stable. In addition, the second elastic member 70 has good elasticity, so that the tolerances between the adjacent cells 20 can be eliminated by the second elastic member 70, and an expansion space can be created for a bulge of the cell 20, thereby improving the stability and reliability of the battery pack 100.

On the other hand, the vapor chamber 30 is provided only at an end of the main side 21 close to the main top 23, and the second elastic member 70 is provided at remaining regions of the main side 21. Therefore, the vapor chamber 30 does not need to be applied on an entire surface between the adjacent cells 20, so that the amount of material of the vapor chamber 30 can be reduced, and the overall cost of the battery pack 100 can be reduced. Thus, the battery pack 100 of the present disclosure has a cost advantage.

In some embodiments, as shown in FIG. 5, a sum of thickness of the first elastic member 60 and the adjacent vapor chambers 30 is same as a thickness of the second elastic member 70. Therefore, the spacing between the cells 20 is same, so that the adjacent vapor chambers 30 can be tightly attached to the corresponding main sides 21.

In some embodiments, the first elastic member 60 and the second elastic member 70 are formed as an integrated structure. In some embodiments, the first elastic member 60 and the second elastic member 70 are integrated, and the first elastic member 60 and the second elastic member 70 can be manufactured in one-go. There is no need to manufacture the first elastic member 60 and the second elastic member 70 separately, the overall processing process can be simplified and the production efficiency can be improved.

In some embodiments, a ratio of a height of the first elastic member 60 to a height of the second elastic member 70 is defined as α, and a value of α satisfies: 0.5≤α≤1. The value of α may be 0.5, 0.6, 0.7, 0.8, 0.9, 1.0, and the like. Within this range, the first elastic member 60 may preferably protect the vapor chamber 30, and the second elastic member 70 may preferably protect the cell 20.

In some embodiments, a thickness of the vapor chamber 30 is defined as D5, and a value of D 5 satisfies: 0.4 mm≤D5≤4mm. The value of D5 may be 0.4, 0.8, 1.0, 1.5, 1.8, 2.2, 2.6, 3.0, 3.4, 3.6, 3.8, 4.0, and the like. In this range, the vapor chamber 30 has a good heat dissipation effect for the cell 20, and does not occupy an excessive mounting space of the cell 20. As such, the energy density of the battery cluster is not reduced.

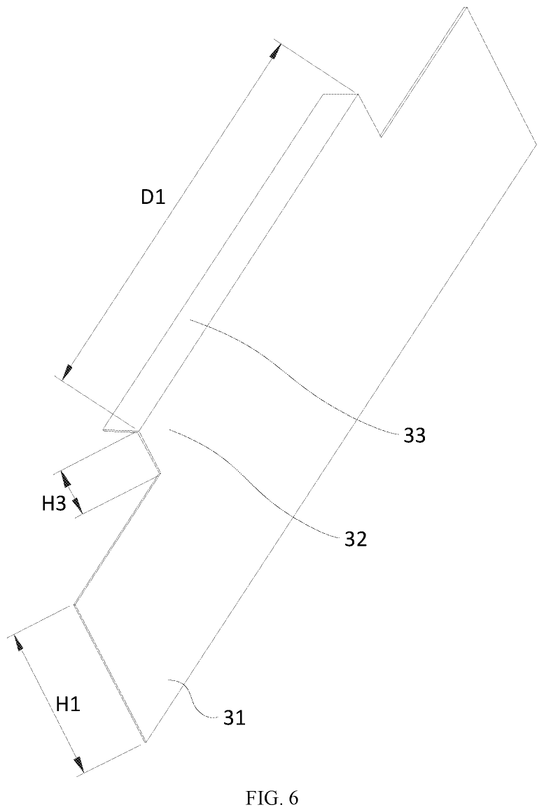

References are made to FIG. 1 to FIG. 6, and FIG. 6 is a schematic structural diagram of an exemplary vapor chamber 30 according to an embodiment of the present disclosure.

The vapor chamber 30 includes a main body 31, an extending portion 32, and a bending portion 33. The main body 31 is positioned between the adjacent cells 20, and the extending portion 32 extends beyond the main top 23 in a direction away from the cells 20. The bending portion 33 is bent relative to the extending portion 32, and an included angle between the bending portion 33 and the extending portion 32 may be 90 degrees, 80 degrees, or the like. The bending portion 33 and the heat-dissipating member 40 are attached to each other. The heat on the cell 20 is first transferred to the main body 31, then to the extending portion 32, then to the bending portion 33, and finally to the heat-dissipating member 40.

In some embodiments, the extending portion 32 is located outside the cell 20 and beyond the main top 23, and the bending portion 33 is bent relative to the extending portion 32 in the direction toward the cell 20, so that the areas for the heat exchange between the vapor chamber 30 and the heat-dissipating member 40 can be increased, and the vapor chamber 30 is improved in its heat dissipating performance to outside.

H1, and H1 is shown with the main body 31 in FIG. 6. A height of the main side 21 is defined as H2, and H2 is shown with the main side 21 in FIG. 4. A value of H1/H2 satisfies: 0.2≤H1/H2≤0.5, and a value of H1/H2 may be 0.2, 0.3, 0.4, 0.5, or the like. This value is intended to mean a range in which the main body 31 occupies the main side 21 in the height direction of the cell 20. In this range, the vapor chamber 30 can perform a better heat dissipation for the end of the cell 20 provided with the poles, and no excessive vapor chamber is needed. When the value of H1/H2 is less than this range, the heat dissipation effect of the vapor chamber 30 on the end of the cell 20 provided with the poles is significantly reduced. When the value of H1/H2 is greater than this range, the heat dissipation effect of the vapor chamber 30 on the cell 20 cannot be significantly improved. Therefore, the heat dissipation of the cell 20 can be achieved while saving the material of the vapor chamber 30 to its best.

In an alternative embodiment, a height of the extending portion 32 is defined as H3, and a value of H3 satisfies: 1 mm≤H3≤20 mm. H3 is shown with the extending portion 32 in FIG. 6, and the value of H3 may be 1 mm, 3 mm, 5 mm, 8 mm, 9 mm, 12 mm, 13 mm, 15 mm, 18 mm, 20 mm, or the like. As shown in FIG. 6, the height of the extending portion 32 is a distance between the bending portion and the main body 31, that is, the extending portion 32 increases a distance from the bending portion to the cell 20, thereby avoiding interference between the bending portion and parts such as a pole or an aluminum bar, and ensuring that the cell 20 can be properly assembled.

In an alternative embodiment, a width of the extending portion 32 is defined as D1, and D1 is shown with the extending portion 32 in FIG. 6. A width of the main side 21 is defined as D2, and D2 is shown with the main side 21 in FIG. 4. A value of D1/D2 satisfies: 0.5≤D1/D2≤0.8, and the value of D1/D2 may be 0.5, 0.6, 0.7, 0.8, or the like. This value is intended to mean a range in which the extending portion 32 occupies the main side 21 in the width direction of the cell 20. The extending portion 32 has a gap with respect to the main side 21. In this range, the extending portion 32 can transmit the heat well. Therefore, the vapor chamber 30 can dissipate the heat from the end of the cell 20 provided with the poles well without shielding the connecting pieces connected to the adjacent cells 20. When the value of D1/D2 is less than this range, the ability of the extending portion 32 to transfer the heat is limited, and the effective for the vapor chamber 30 to dissipate heat on the end of the cell 20 provided with the poles is significantly reduced.

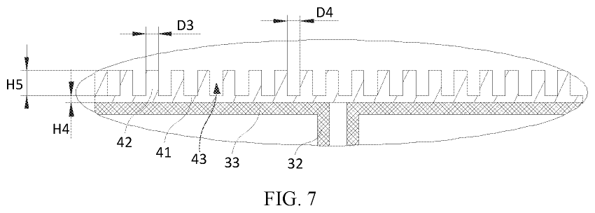

References are made to FIG. 1 to FIG. 7, and FIG. 7 is a schematic partially enlarged view of an exemplary region A in FIG. 5 according to an embodiment of the present disclosure.

The heat-dissipating member 40 includes a base 41 and a plurality of fins 42, the base 41 is in contact with a part of the vapor chamber 30 extending from the main top, and the plurality of fins 42 are spaced on a side of the base 41 away from the vapor chamber 30. The fins 42 are in the form of thin sheets, and an air duct 43 is defined between the adjacent fins 42, thereby increasing a contact area between the heat-dissipating member 40 and the air, thereby improving the heat dissipation effect. The heat-dissipating member 40 may also be other elements with high heat-absorption such as a liquid-cooled plate. Alternatively, the fins 42 extend in a direction perpendicular to the main side 21, and the air-exhausting member 50 is provided toward the air duct 43 defined by the adjacent fins 42. A directional air flow provided by activating the air-exhausting member 50 can directly enter the air duct 43 and carry away the hot air in the air duct 43, thereby ensuring the efficiency of the air flow.

In an alternative embodiment, a thickness of each of the fins 42 is defined as D3, and D3 is shown with the fin 42 in FIG. 7. A spacing between the adjacent fins 42 is defined as D4, and D4 is shown with the fin 42 in FIG. 7. A value of D4/D3 indicates a multiple relationship between the width of the air duct 43 and the thickness of the fin 42. The value of D4/D3 satisfies: 3≤D4/D3≤7, e.g., the value of D4/D3 may be 3, 4, 5, 6, 7. In this range, the air flow in the air duct 43 is smoother and the wind resistance is significantly reduced, thereby increasing the efficiency of the air circulation.

In an alternative embodiment, a height of the base 41 is defined as H4, and H4 is shown with the base 41 in FIG. 7. A height of the fin 42 is H5, and H5 is shown with the fin 42 in FIG. 7. A value of H5/H4 indicates a multiple relationship between the height of the fin 42 and the height of the base 41. The value of H5/H4 satisfies: 2≤H5/H4≤10, e.g., and the value of H5/H4 may be 2, 3, 4, 5, 6, 7, 8, 9, 10. In this range the base 41 can better support the weight of the fin 42 without deformation, and in addition, the fin 42 can maximize a contact area with the air to improve heat dissipation efficiency.

What is claimed is:

1. A battery pack, comprising:
a case comprising an accommodating cavity;
a plurality of cells spaced in the accommodating cavity, wherein each of the plurality of cells comprises a main side and a main top, main sides of adjacent cells of the plurality of cells are opposite to each other, and each main top is a face of the cell through which poles of the cell extend;
a plurality of vapor chambers, wherein each of the plurality of vapor chambers is attached to an end of the main side closer to the main top, and the vapor chamber has at least a protruded part relative to the main top;
a heat-dissipating member connected to the protruded part of the vapor chamber; and
an air-exhausting member disposed in the accommodating cavity toward the heat-dissipating member.

2. The battery pack according to claim 1, wherein the battery pack comprises a first elastic member disposed between adjacent vapor chambers of the plurality of vapor chambers.

3. The battery pack according to claim 2, wherein the battery pack comprises a second elastic member disposed between the adjacent cells, and the second elastic member is attached to the main side.

4. The battery pack according to claim 3, wherein the first elastic member and the second elastic member are formed as an integrated structure.

5. The battery pack according to claim 3, wherein a ratio of a height of the first elastic member to a height of the second elastic member is α, and a value of α satisfies: 0.5≤α≤1.

6. The battery pack according to claim 1, wherein the vapor chamber comprises a main body, an extending portion, and a bending portion sequentially connected; the main body is positioned between the adjacent cells; the extending portion is positioned beyond the main top; the bending portion is bent relative to the extending portion; and the bending portion and the heat-dissipating member are attached to each other.

7. The battery pack according to claim 6, wherein a height of the main body is H1, a height of the main side is H2, and a value of H1/H2 satisfies: 0.2≤H1/H2≤0.5.

8. The battery pack according to claim 6, wherein a height of the extending portion is H3, and a value of H3 satisfies: 1 mm≤H3≤20 mm.

9. The battery pack according to claim 6, wherein a width of the extending portion is D1, a width of the main side is D2, and a value of D1/D2 satisfies: 0.5≤D1/D2≤0.8.

10. The battery pack according to claim 1, wherein a thickness of the vapor chamber is D5, and a value of D5 satisfies: 0.4 mm≤D5≤4 mm.

11. The battery pack according to claim 1, wherein the heat-dissipating member comprises a base and a plurality of fins, the base is in contact with the protruded part of the vapor chamber, and the plurality of fins are spaced on a side of the base away from the vapor chamber.

12. The battery pack according to claim 11, wherein a thickness of each of the plurality of fins is D3, a spacing between adjacent fins of the plurality of fins is D4, and a value of D4/D3 satisfies: 3≤D4/D3≤7.

13. The battery pack according to claim 11, wherein a height of the base is H4, a height of each of the plurality of fins is H5, and a value of H5/H4 satisfies: 2≤H5/H4≤10.

14. The battery pack according to claim 11, wherein the plurality of fins extend in a direction perpendicular to the main side, and the air-exhausting member is provided toward an air duct formed by adjacent fins of the plurality of fins.

15. A battery cluster, comprising a plurality of battery packs, each battery pack comprising:
a case comprising an accommodating cavity;
a plurality of cells spaced in the accommodating cavity, wherein each of the plurality of cells comprises a main side and a main top, main sides of adjacent cells of the plurality of cells are opposite to each other, and each main top is a face of the cell through which poles of the cell extend;
a plurality of vapor chambers, wherein each of the plurality of vapor chambers is attached to an end of the main side closer to the main top, and the vapor chamber has at least a protruded part relative to the main top;
a heat-dissipating member connected to the protruded part of the vapor chamber; and
an air-exhausting member disposed in the accommodating cavity toward the heat-dissipating member.

16. The battery cluster according to claim 15, wherein the case comprises a cover and a bottom, the cover and the bottom are connected to form the accommodating cavity, the plurality of cells are provided on the bottom of the battery pack, the bottom comprises an air-cooling chamber and a liquid-cooling chamber spaced from each other, wherein the air-cooling chamber and the liquid-cooling chamber each extend in a direction perpendicular to the main side, the air-cooling chamber is in communication with the accommodating cavity, and the liquid-cooling chamber is configured for receiving a coolant,
wherein the plurality of battery packs are stacked together, and the cover of one of the plurality of battery packs is connected to the bottom of an adjacent one of the plurality of battery packs.

17. The battery cluster according to claim 16, wherein the air-cooling chamber and the liquid-cooling chamber are arranged along a thickness direction of the bottom, and the air-cooling chamber is interposed between the cell and the liquid-cooling chamber.

18. The battery cluster according to claim 15, wherein the battery pack comprises a first elastic member disposed between adjacent vapor chambers of the plurality of vapor chambers; and the battery pack comprises a second elastic member disposed between the adjacent cells, and the second elastic member is attached to the main side.

19. The battery cluster according to claim 15, wherein the vapor chamber comprises a main body, an extending portion, and a bending portion sequentially connected; the main body is positioned between the adjacent cells; the extending portion is positioned beyond the main top; the bending portion is bent relative to the extending portion; and the bending portion and the heat-dissipating member are attached to each other.

20. The battery cluster according to claim 15, wherein the heat-dissipating member comprises a base and a plurality of fins, the base is in contact with the protruded part of the vapor chamber, and the plurality of fins are spaced on a side of the base away from the vapor chamber.
